(19) United States
(12) Patent Application Publication
(10) Pub. No.: US 2026/0120343 A1
(43) Pub. Date: Apr. 30, 2026

(54) METHOD, APPARATUS, DEVICE AND STORAGE MEDIUM FOR INFORMATION PROCESSING

(71) Applicants: Lemon Inc., Grand Cayman (KY); Beijing Zitiao Network Technology Co., Ltd., Beijing (CN)

(72) Inventors: Zilong Huang, Singapore (SG); Qinghao Ye, Beijing (CN); Bingyi Kang, Los Angeles, CA (US); Jiashi Feng, Singapore (SG); Haoqi Fan, Los Angeles, CA (US)

(21) Appl. No.: 19/374,111

(22) Filed: Oct. 30, 2025

(30) Foreign Application Priority Data
Oct. 30, 2024 (CN) 202411526406.3

(51) Int. Cl. G06T 11/00; G06F 40/284; G06N 20/00

(52) U.S. Cl. CPC G06T 11/00; G06F 40/284; G06N 20/00

(57) ABSTRACT

The disclosure relates to a method, an apparatus, a device and a computer readable storage medium for information processing. An example method includes: obtaining target content to be processed, the target content comprising image content; and generating a target feature representation of the target content with a target model, wherein the target model is trained through: obtaining a training image and a training text corresponding to the training image; generating a first feature representation corresponding to the training text, the first feature representation indicating whether the training text comprises a set of predetermined text elements; processing the training image with a target model to be trained to generate a second feature representation; and training the target model based on a difference between the first feature representation and the second feature representation.

### CROSS-REFERENCE

The present application claims priority to Chinese Patent Application No. 202411526406.3, filed on Oct. 30, 2024, and entitled “METHOD, APPARATUS, DEVICE AND STORAGE MEDIUM FOR INFORMATION PROCESSING”, the entirety of which is incorporated herein by reference.

### FIELD

Example embodiments of the present disclosure generally relate to the field of computers, and in particular, to a method, an apparatus, a device and a computer-readable storage medium for information processing.

### BACKGROUND

Cross-modal technology is an active research direction in the field of artificial intelligence, which is intended to enable a machine to understand and process information in different modals, such as an visual image and natural language. A core challenge of this technique is how to effectively fuse and correlate data in different modals so that the machine can understand and recognize image content through language descriptions like humans, or generate descriptive text from image content. As the availability of large-scale image-text datasets increases, cross-modal learning becomes particularly important in pre-trained models that can capture rich visual and linguistic features, thereby achieving better performance in a variety of downstream tasks.

### SUMMARY

In a first aspect of the present disclosure, a method for information processing is provided. The method comprises: obtaining target content to be processed, the target content comprising image content; and generating a target feature representation of the target content with a target model, wherein the target model is trained through: obtaining a training image and a training text corresponding to the training image; generating a first feature representation corresponding to the training text, the first feature representation indicating whether the training text comprises a set of predetermined text elements; processing the training image with a target model to be trained to generate a second feature representation; and training the target model based on a difference between the first feature representation and the second feature representation.

In a second aspect of the present disclosure, an apparatus for information processing is provided. The apparatus comprises: an obtaining module, configured to obtain target content to be processed, the target content comprising image content; and a generation module, configured to generate a target feature representation of the target content with a target model, wherein the target model is trained through: obtaining a training image and a training text corresponding to the training image; generating a first feature representation corresponding to the training text, the first feature representation indicating whether the training text comprises a set of predetermined text elements; processing the training image with a target model to be trained to generate a second feature representation; and training the target model based on a difference between the first feature representation and the second feature representation.

In a third aspect of the present disclosure, an electronic device is provided. The device comprises: at least one processor; and at least one memory coupled to the at least one processor and storing instructions for execution by the at least one processor. The instructions, when executed by the at least one processor, causing the device to perform the method of the first aspect.

In a fourth aspect of the present disclosure, a computer-readable storage medium is provided. The computer-readable storage medium stores a computer program, and the computer program is executable by a processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments according to the present disclosure may be implemented;

FIG. 2 illustrates a flowchart of an example process of information processing according to some embodiments of the present disclosure;

FIG. 3 illustrates a schematic block diagram of an example process of information processing according to some embodiments of the present disclosure;

FIG. 4 illustrates a schematic structural block diagram of an example apparatus for information processing according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined with any other embodiment described in the same section/subsection and/or different sections/subsections in any manner.

In the description of the embodiments of the present disclosure, the terms “including” and similar terms should be understood as open inclusion, that is, “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or same objects. Other explicit and implicit definitions may also be included below.

Embodiments of the present disclosure may relate to data of a user, acquisition and/or use of data, and the like. These aspects all follow the corresponding laws and regulations and related regulations. In the embodiments of the present disclosure, all data is collected, obtained, processed, machined, forwarded, used, etc., all of which are performed on the premise that the user knows and confirms. Accordingly, when implementing the embodiments of the present disclosure, the types of the data or information that may be involved, the usage scope, the usage scenario, and the like should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, processing may be processed on the premise of having a legality basis (for example, obtaining consent of a personal information subject, or necessary for performing a fulfillment contract), and processed only within a specified or agreed range. The user rejects personal information other than necessary information required by the basic function, and does not affect the basic function of the user usage.

As mentioned above, the understanding and generation capability of cross-modal information is an important challenge in the field of machine learning. Conventionally, a Contrastive Language-Image Pre-training (CLIP) model may be trained to obtain a feature representation capable of understanding image content and an associated text with large-scale network image-text pair data by means of contrastive learning, thereby exhibiting excellent performance on zero sample visual recognition and downstream task fine-tuning. However, the CLIP model requires a huge batch size and a large amount of computing resources for text encoding, which limits their accessibility for researchers with limited resources.

The embodiment of the disclosure provides a solution for information processing. The solution includes: obtaining target content to be processed, the target content comprising image content; and generating a target feature representation of the target content with a target model. The target model is trained through: obtaining a training image and a training text corresponding to the training image; generating a first feature representation corresponding to the training text, the first feature representation indicating whether the training text comprises a set of predetermined text elements; processing the training image with a target model to be trained to generate a second feature representation; and training the target model based on a difference between the first feature representation and the second feature representation.

In one aspect, with a set of predetermined text elements to generate the feature representation corresponding to the training text, embodiments of the present disclosure can avoid using a text encoder, thereby simplifying the training process, and may better maintain the integrity of the information. In another aspect, the embodiments of the present disclosure can further reduce the demand for computing resources and improve the training efficiency.

Various example implementations of this solution are described in detail below in conjunction with the accompanying drawings.

### Example Environment

FIG. 1 illustrates a schematic diagram of an example environment 100 in which embodiments of the present disclosure can be implemented. As shown in FIG. 1, the example environment 100 may include an electronic device 110.

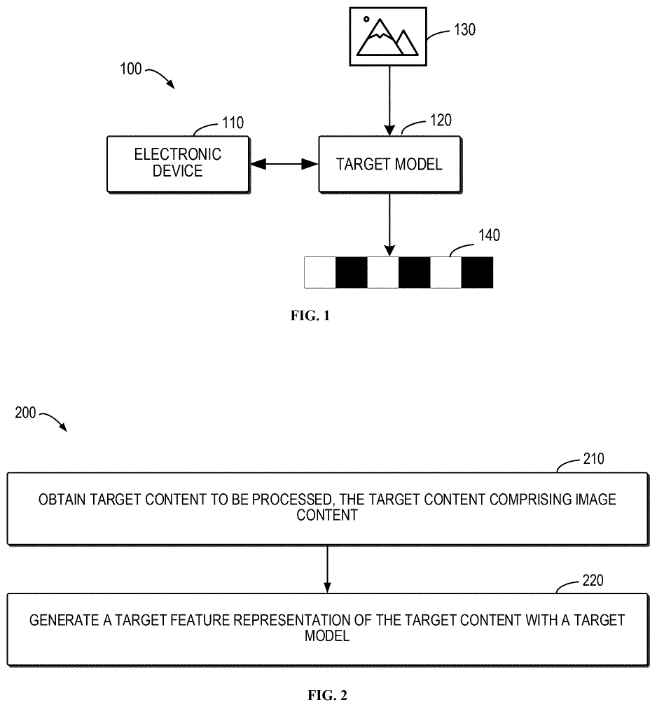

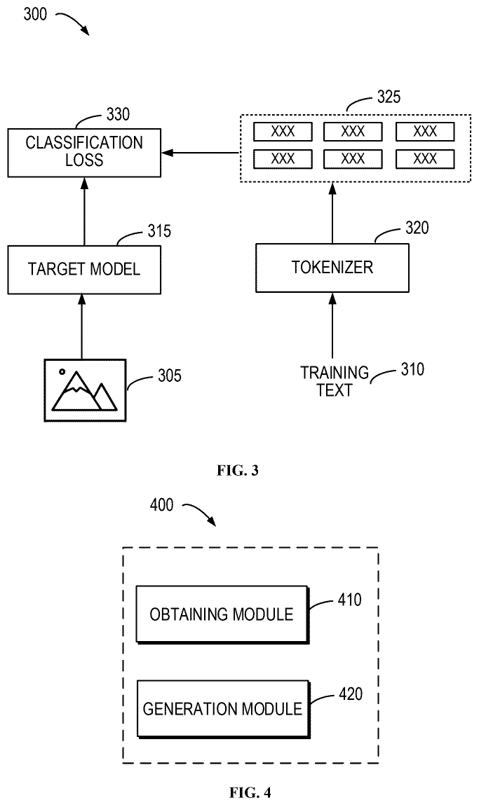

In this example environment 100, the electronic device 110 may deploy a target model 120. The target model 120 may process a target content 130 to generate a corresponding target feature representation 140. As an example, the target content 130 may comprise image content, e.g., a picture or a video. The target feature representation 140 may be further provided for appropriate vision related tasks, such as an image classification task, an entity segmentation task, a description text generation task, and the like. The specific structure and process regarding the target model 120 will be described in detail below with reference to FIGS. 2 and 3.

The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.).

The electronic device 110 may also be a standalone physical server, or may be a server cluster or a distributed system composed of multiple physical servers, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The electronic device 110 may include, for example, a computing system/server, such as a mainframe, an edge computing node, a computing device in a cloud environment, or the like.

It should be understood that the structures and functions of the various elements in the environment 100 are described for exemplary purposes only and do not imply any limitation to the scope of the present disclosure.

Some example embodiments of the present disclosure will be described below with continued reference to the accompanying drawings.

### Example Processes

FIG. 2 illustrates a flowchart of an example process 200 of information processing according to some embodiments of the present disclosure. The process 200 may be implemented at electronic device 110. The process 200 is described below with reference to FIG. 1.

As shown, at block 210, the electronic device 110 obtains target content 130 to be processed, the target content comprising image content. As an example, the target content 130 may comprise static image content and/or dynamic image content, for example. Alternatively, the target content 130 may also comprise, for example, a combination of image content and audio content, for example, video content.

At block 220, the electronic device 110 generates the target feature representation 140 of the target content 130 with the target model 120. As will be described in detail below, the target model 120 may generate a feature vector of image content for a subsequent vision related task.

The training process 300 of the target model 130 will be further described below with reference to FIG. 3. The training process 300 may be performed, for example, by an appropriate training device.

In some embodiments, the training device may obtain the training image 305 and the training text 310 corresponding to the training image 305. As an example, the training text 310 may be, for example, a textual description about the training image 305.

In some embodiments, the training device may, for example, obtain a sample set including a plurality of image-text pairs, which may for example be represented as [symbol] ={(Iᵢ, Tᵢ)|i∈[1,N]}, which comprise N pairs of image I and text T.

Further, the training device may generate a first feature representation corresponding to the training text, wherein the first feature representation indicates whether the training text comprises a set of predetermined text elements. Rather than using a conventional text encoder, the training device may, for example, convert the training text 310 into a set of text tokens 325 with a tokenizer 320. Each text token may comprise a subword obtained by segmenting the training text 310 by the tokenizer 320.

Further, the training device may determine the first feature representation based on the determined set of text tokens 325. Specifically, a set of predetermined text elements may be represented as V′, which may comprise a plurality of predetermined subwords. Further, the first feature representation may be represented as a plurality of classification labels C with respect to the set of predetermined text elements.

Specifically, the first feature representation may be a multi-dimensional vector, and each dimension of the vector may correspond to a predetermined text element. Correspondingly, the plurality of classification labels C may be converted into a multi-dimensional vector corresponding to the set of predetermined text elements, and the value of each dimension may indicate whether the corresponding text element is comprised in the set of text tokens 325.

For example, the multi-dimensional vector may comprise a first dimension corresponding to a first text element. If the first text element is comprised in the set of text tokens 325, the first value of the first dimension may be set to a first value, e.g., 1. Conversely, if a second text element is not comprised in the set of text tokens 325, a second value of the second dimension may be set to a second value, e.g., 0.

In this way, embodiments of the present disclosure do not require any additional text encoder, thereby simplifying the training process and better maintaining the integrity of the information.

With continued reference to FIG. 3, the training device may further process the training image 305 with the target model 315 to be trained to generate a second feature representation. In some embodiments, the target model 315 may comprise, for example, a visual encoding unit and a classification unit. The visual encoding unit may process the training image 305 to generate a visual feature. As an example, a visual encoding unit may be implemented using an appropriate visual converter.

Further, the classification unit may further process the generated visual feature to generate a second feature representation, wherein the classification unit comprises a plurality of classification heads corresponding to a set of predetermined text elements. As an example, the classification unit may comprise a global average pooling layer and a linear layer as a classification head.

Specifically, the classification unit may implement a multi-classification task corresponding to the set of predetermined text elements to generate the second feature representation. Similar to the first feature representation, the second feature representation may be a multi-dimensional vector having a plurality of dimensions corresponding to the set of predetermined text elements.

Additionally, the training device may train the target model 315 based on a difference between the generated first feature representation and the second feature representation. In some embodiments, the training device may determine the classification loss 330 based on a difference between the first feature representation and the second feature representation.

As an example, the classification loss 330 may be represented as a sum of a plurality of classification losses corresponding to the plurality of classification dimensions:

$${ℓ}_{ce} = - {\sum }_{c = 1}^{V} \hat{{y}_{c}} log \frac{{e}^{{x}_{c}}}{{\sum }_{{c}^{′}} {e}^{{x}_{{c}^{′}}}} \qquad ( 1 )$$

wherein ŷ_{c} may be a ground truth label determined based on the first feature representation, x_{c} is the second feature representation generated based on the training image 305, and c represents the classification label.

In some embodiments, the first feature representation may be directly used as a ground truth label. Alternatively, the training device may further determine, based on frequency information of a set of predetermined text elements, a plurality of weights corresponding to a plurality of dimensions (that is, different classification labels). The frequency information may indicate a number of samples comprising a corresponding text element in a sample set.

As an example, the training device may determine the weight corresponding to each dimension based on the following formula:

$${w}_{c} = log ( \frac{\vert 𝒟 \vert}{1 + df ( c )} ) \qquad ( 2 )$$

wherein [symbol] represents the total number of samples in the sample set, df (c) represents the number of samples comprising the text element (i.e., subword) c.

In some embodiments, ŷ_{c} in the formula (1) may also be determined based on a plurality of weights corresponding to the plurality of dimensions:

$${\hat{y}}_{c} = \frac{{w}_{c} {y}_{c}}{{\sum }_{{c}^{′}} {w}_{{c}^{′}} {y}_{{c}^{′}}} \qquad ( 3 )$$

It can be seen that, according to formula (3), the target weight corresponding to the target dimension is negatively correlated with a number of samples comprising the target text element in the sample set. That is, the less the number of samples containing a particular text element (i.e., a subword), the text element may be considered to have more effective supervision information and may be given a higher weight.

Thus, the formula (1) can consider the inverse document frequency of different text elements (i.e., subwords), so that the text elements (e.g., lower frequency subwords) that can provide more effective supervision information can be considered more in the training process, and consideration of text elements (e.g., higher frequency subwords) that fail to provide effective supervision information can be reduced.

Based on the process described above, in one aspect, with a set of predetermined text elements to generate the feature representation corresponding to the training text, embodiments of the present disclosure can avoid using a text encoder, thereby simplifying the training process, and may better maintain the integrity of the information. In another aspect, the embodiments of the present disclosure can further reduce the demand for computing resources and improve the training efficiency.

### Example Apparatus and Device

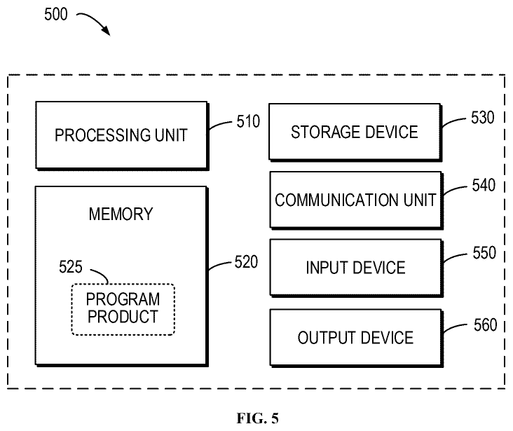

Embodiments of the present disclosure also provide a corresponding apparatus for implementing the above method or process. FIG. 4 illustrates a schematic structural block diagram of an example apparatus 400 for information processing according to some embodiments of the present disclosure. The apparatus 400 may be implemented or included in the electronic device 110. The various modules/components in the apparatus 400 may be implemented by hardware, software, firmware, or any combination thereof.

As shown in FIG. 4, the apparatus 400 comprises: an obtaining module 410, configured to obtain target content to be processed, the target content comprising image content; and a generation module 420, configured to generate a target feature representation of the target content with a target model, wherein the target model is trained through: obtaining a training image and a training text corresponding to the training image; generating a first feature representation corresponding to the training text, the first feature representation indicating whether the training text comprises a set of predetermined text elements; processing the training image with a target model to be trained to generate a second feature representation; and training the target model based on a difference between the first feature representation and the second feature representation.

In some embodiments, generating a first feature representation corresponding to the training text comprises: converting the training text into a set of text tokens with a tokenizer; and determining the first feature representation based on the set of text tokens, the first feature representation comprising a plurality of dimensions corresponding to the set of predetermined text elements, and a value of each dimension indicating whether a corresponding text element is comprised in the set of text tokens.

In some embodiments, a first dimension corresponding to a first text element is set as a first value in response to the first text element being comprised in the set of text tokens; and/or a second dimension corresponding to a second text element is set as a second value in response to the second text element being not comprised in the set of text tokens.

In some embodiments, training the target model based on a difference between the first feature representation and the second feature representation comprises: determining, based on frequency information of the set of predetermined text elements, a plurality of weights corresponding to the plurality of dimensions, the frequency information indicating a number of samples comprising a corresponding text element in a sample set; determining a plurality of classification losses corresponding to the plurality of dimensions based on the difference between the first feature representation and the second feature representation; applying the plurality of weights to the plurality of classification losses to determine a target loss; and training the target model based on the target loss.

In some embodiments, a target weight corresponding to a target dimension is negatively correlated with a number of samples comprising a target text element in the sample set.

In some embodiments, processing the training image with a target model to be trained to generate a second feature representation comprises: processing the training image with a visual encoding unit in the target model to generate a visual feature; and processing the visual feature with a classification unit in the target model to generate the second feature representation, the classification unit comprising a plurality of classification heads corresponding to the set of predetermined text elements.

In some embodiments, the apparatus 400 further comprises a providing module configured to provide the target feature representation for a vision related task.

FIG. 5 illustrates a block diagram of an electronic device 500 in which one or more embodiments of the present disclosure may be implemented. It should be understood that the electronic device 500 illustrated in FIG. 5 is merely exemplary and should not constitute any limitation on the functionality and scope of the embodiments described herein. The electronic device 500 shown in FIG. 5 may be configured to implement the electronic device 110 in FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, multiple processing units execute computer-executable instructions in parallel to improve parallel processing capabilities of electronic device 500.

Electronic device 500 typically includes a plurality of computer storage media. Such media may be any available media accessible to the electronic device 500, including, but not limited to, volatile and non-volatile media, removable and non-removable media. The memory 520 may be a volatile memory (e.g., registers, caches, random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium, such as a flash drive, magnetic disk, or any other medium, which may be capable of storing information and/or data and may be accessed within electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 implements communication with another electronic device through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce apparatus to implement the functions/acts specified in one or more blocks of the flowchart and/or block diagrams. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in one or more blocks of the flowchart and/or block diagrams.

The computer-readable program instructions may be loaded onto a computer, other programmable data processing apparatus, or other device, such that a series of operational steps are performed on a computer, other programmable data processing apparatus, or other device to produce a computer-implemented process such that the instructions executed on a computer, other programmable data processing apparatus, or other device implement the functions/acts specified in one or more blocks of the flowchart and/or block diagrams.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for information processing, comprising:
obtaining content to be processed, the content comprising image content; and
generating a feature representation of the content with a model, wherein the model is trained through: obtaining a training image and a training text corresponding to the training image; generating a first feature representation corresponding to the training text, the first feature representation indicating whether the training text comprises a set of predetermined text elements; processing the training image with a model to be trained to generate a second feature representation; and training the model based on a difference between the first feature representation and the second feature representation.

2. The method of claim 1, wherein generating a first feature representation corresponding to the training text comprises:
converting the training text into a set of text tokens with a tokenizer; and
determining the first feature representation based on the set of text tokens, the first feature representation comprising a plurality of dimensions corresponding to the set of predetermined text elements, and a value of each dimension indicating whether a corresponding text element is comprised in the set of text tokens.

3. The method of claim 2, wherein:
a first dimension corresponding to a first text element is set as a first value in response to the first text element being comprised in the set of text tokens; and/or
a second dimension corresponding to a second text element is set as a second value in response to the second text element being not comprised in the set of text tokens.

4. The method of claim 2, wherein training the model based on a difference between the first feature representation and the second feature representation comprises:
determining, based on frequency information of the set of predetermined text elements, a plurality of weights corresponding to the plurality of dimensions, the frequency information indicating a number of samples comprising a corresponding text element in a sample set;
determining a plurality of classification losses corresponding to the plurality of dimensions based on the difference between the first feature representation and the second feature representation;
applying the plurality of weights to the plurality of classification losses to determine a loss; and
training the model based on the loss.

5. The method of claim 4, wherein a weight corresponding to a dimension is negatively correlated with a number of samples comprising a target text element in the sample set.

6. The method of claim 1, wherein processing the training image with a model to be trained to generate a second feature representation comprises:
processing the training image with a visual encoding unit in the model to generate a visual feature; and
processing the visual feature with a classification unit in the model to generate the second feature representation, the classification unit comprising a plurality of classification heads corresponding to the set of predetermined text elements.

7. The method of claim 1, further comprising:
providing the feature representation of the content for a vision related task.

8. An electronic device, comprising:
at least one processor; and
at least one memory coupled to the at least one processor and storing instructions for execution by the at least one processor, the instructions, when executed by the at least one processor, causing the electronic device to perform acts comprising:
obtaining content to be processed, the content comprising image content; and
generating a feature representation of the content with a model, wherein the model is trained through: obtaining a training image and a training text corresponding to the training image; generating a first feature representation corresponding to the training text, the first feature representation indicating whether the training text comprises a set of predetermined text elements; processing the training image with a model to be trained to generate a second feature representation; and training the model based on a difference between the first feature representation and the second feature representation.

9. The electronic device of claim 8, wherein generating a first feature representation corresponding to the training text comprises:
converting the training text into a set of text tokens with a tokenizer; and
determining the first feature representation based on the set of text tokens, the first feature representation comprising a plurality of dimensions corresponding to the set of predetermined text elements, and a value of each dimension indicating whether a corresponding text element is comprised in the set of text tokens.

10. The electronic device of claim 9, wherein:
a first dimension corresponding to a first text element is set as a first value in response to the first text element being comprised in the set of text tokens; and/or
a second dimension corresponding to a second text element is set as a second value in response to the second text element being not comprised in the set of text tokens.

11. The electronic device of claim 9, wherein training the model based on a difference between the first feature representation and the second feature representation comprises:
determining, based on frequency information of the set of predetermined text elements, a plurality of weights corresponding to the plurality of dimensions, the frequency information indicating a number of samples comprising a corresponding text element in a sample set;
determining a plurality of classification losses corresponding to the plurality of dimensions based on the difference between the first feature representation and the second feature representation;
applying the plurality of weights to the plurality of classification losses to determine a loss; and
training the model based on the loss.

12. The electronic device of claim 11, wherein a weight corresponding to a dimension is negatively correlated with a number of samples comprising a target text element in the sample set.

13. The electronic device of claim 8, wherein processing the training image with a model to be trained to generate a second feature representation comprises:
processing the training image with a visual encoding unit in the model to generate a visual feature; and
processing the visual feature with a classification unit in the model to generate the second feature representation, the classification unit comprising a plurality of classification heads corresponding to the set of predetermined text elements.

14. The electronic device of claim 8, the acts further comprising:
providing the feature representation of the content for a vision related task.

15. A non-transitory computer-readable storage medium having stored thereon a computer program executable by a processor to implement acts comprising
obtaining content to be processed, the content comprising image content; and
generating a feature representation of the content with a model, wherein the model is trained through: obtaining a training image and a training text corresponding to the training image; generating a first feature representation corresponding to the training text, the first feature representation indicating whether the training text comprises a set of predetermined text elements; processing the training image with a model to be trained to generate a second feature representation; and training the model based on a difference between the first feature representation and the second feature representation.

16. The non-transitory computer-readable storage medium of claim 15, wherein generating a first feature representation corresponding to the training text comprises:
converting the training text into a set of text tokens with a tokenizer; and
determining the first feature representation based on the set of text tokens, the first feature representation comprising a plurality of dimensions corresponding to the set of predetermined text elements, and a value of each dimension indicating whether a corresponding text element is comprised in the set of text tokens.

17. The non-transitory computer-readable storage medium of claim 16, wherein:
a first dimension corresponding to a first text element is set as a first value in response to the first text element being comprised in the set of text tokens; and/or
a second dimension corresponding to a second text element is set as a second value in response to the second text element being not comprised in the set of text tokens.

18. The non-transitory computer-readable storage medium of claim 16, wherein training the model based on a difference between the first feature representation and the second feature representation comprises:
determining, based on frequency information of the set of predetermined text elements, a plurality of weights corresponding to the plurality of dimensions, the frequency information indicating a number of samples comprising a corresponding text element in a sample set;
determining a plurality of classification losses corresponding to the plurality of dimensions based on the difference between the first feature representation and the second feature representation;
applying the plurality of weights to the plurality of classification losses to determine a loss; and
training the model based on the loss.

19. The non-transitory computer-readable storage medium of claim 18, wherein a weight corresponding to a dimension is negatively correlated with a number of samples comprising a target text element in the sample set.

20. The non-transitory computer-readable storage medium of claim 15, wherein processing the training image with a model to be trained to generate a second feature representation comprises:
processing the training image with a visual encoding unit in the model to generate a visual feature; and
processing the visual feature with a classification unit in the model to generate the second feature representation, the classification unit comprising a plurality of classification heads corresponding to the set of predetermined text elements.
